(19) United States
(12) Patent Application Publication
(10) Pub. No.: US 2013/0265743 A1
(43) Pub. Date: Oct. 10, 2013

(54) Lamp Structure

(71) Applicant: HUAN-PING LEE, Toufen Township (TW)

(72) Inventor: HUAN-PING LEE, Toufen Township (TW)

(21) Appl. No.: 13/440,979

(22) Filed: Apr. 5, 2012

(51) Int. Cl. F21V 33/00; H01R 33/00

(52) U.S. Cl. 362/96; 362/640

(57) ABSTRACT

A lamp structure comprises a base, a light-guiding body, and a shade. The base defines an opening at a top thereof and multiple air holes at a periphery thereof, and provided with an electrical plug and a control switch. The interior of the base is provided with a control circuit board including a light module and a negative-ion generator, wherein the control circuit board is electrically connected with the electrical plug and the control switch. The light-guiding body is fitted into the base via the opening of the base, so that the light emitting from the light module can be directed out of the base. The shade is mounted on top of the base, wherein the shade is configured to be a hollow cylinder defining multiple light-through holes on a periphery thereof, whereby the light going out of the base can go through the light-through holes of the shade.

### TECHNICAL FIELD OF THE INVENTION

The present invention relates to a lamp structure that can produce a lighting effect with purification of the ambient air, especially suitable to be served as a nightlight or other similar devices.

### DESCRIPTION OF THE PRIOR ART

Since modem man has a higher requirement for the quality of domestic life, for example, for relaxing the body and mind and creating a good environment, an aromatherapy lamp is usually employed. Most of conventional aromatherapy lamps use a candle or a tungsten light bulb as a heating medium to allow the essential oils with water to be evaporated into the environment. Generally, the structure of a conventional aromatherapy lamp includes an essential oil container on a ceramic lamp, in which a candle or a tungsten light bulb is installed for heating the container to allow the essential oil contained therein to be evaporated, thereby creating a fragrant environment to achieve the goal of soothing the body and the mind.

Although the lamps employing candles can spread the scent of the essential oils, the candles may create an unpleasant odor in a room during the burning process, and produce carbon dioxide from burning oxygen, which is bad to the health. Furthermore, a burning candle can bring a potential risk, especially while the user is in sleep. As to the lamps employing tungsten light bulbs, since most of the electrical energy used by the tungsten light bulbs is converted into unavailable heat energy, they are not an ideal means to create fragrance for the environment.

Thus, there is a need to develop a safe and environment-friendly lamp structure that can overcome the drawbacks of the conventional aromatherapy lamps.

### SUMMARY OF THE INVENTION

The primary object of the present invention is to provide a lamp structure that can purify the ambient air and provide a distinctive atmosphere for a room.

To achieve the above object, the lamp structure of the present invention may comprise a base, a light-passing body, and a shade. The base defines an opening at a top thereof and a plurality of air holes at a bottom thereof, and provided with an electrical plug and a control switch at a periphery thereof The interior of the base is provided with a control circuit board including a light module and a negative-ion generator, wherein the control circuit board is electrically connected with the electrical plug and the control switch provided at the periphery of the base. The light-passing body is fitted into the opening defined at the top of the base, corresponding to the light module, so that the light emitting from the light module can pass through the light-passing body. The shade is mounted on top of the base, wherein the shade is configured to be a hollow cylinder defining a plurality of light-through holes on a periphery thereof, whereby the light emitting from the light-passing body can go through the light-through holes of the shade.

According to one aspect of the present invention, the control switch is a 3-position switch, which includes a first position, a second position, and a third position, whereby the first position can control the light module, the second position can control the negative-ion generator, and the third position can control both of the light module and the negative-ion generator.

According to another aspect of the present invention, the interior of the shade is furnished with a perfume bottle.

According to a further aspect of the present invention, the interior of the shade is furnished with a container.

According to a still further aspect of the present invention, the perfume bottle is supplied with alcohol, aromatic compounds, water, essential oils, perfumes or balsams of natural plants, or any combinations of the foregoing.

The present invention has the following advantages over the prior art:

1. The fragrant materials can be added to the lamp structure of the present invention to cooperate with the lighting function, without consuming too much electrical energy to change the condition of a room and achieve the goal of relaxation.

2. The negative-ion generator of the lamp structure of the present invention can be activated to purify the ambient air of a room by triggering a control switch thereof.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view of one embodiment of the present invention.

FIG. 2 is an exploded view of the embodiment of the present invention.

FIG. 3 is a 3-dimenionsal view of the base of the embodiment of the present invention.

FIG. 4 shows another arrangement of the control circuit board provided in the base of the embodiment.

FIG. 5 shows a working view of the embodiment of the present invention.

FIG. 6 shows another working view of the embodiment of the present invention.

### DETAILED DESCRIPTION OF THE PREFERRED EMBODIMENTS

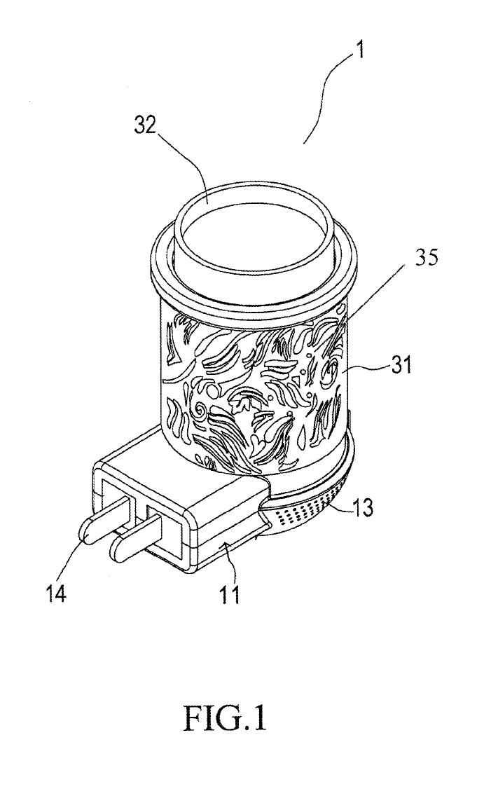

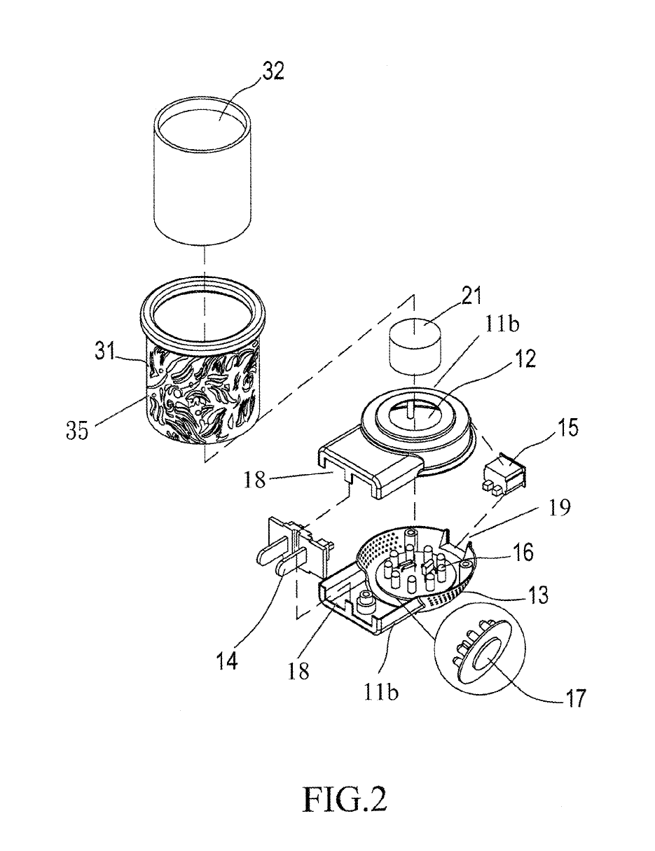

Referring to FIGS. 1 and 2, the lamp structure of the present invention generally comprises a base 11, a light-passing body 21, and a shade 31. The base 11 defines an opening 12 at a top thereof and a plurality of air holes 13 at a bottom thereof, and provided with an electrical plug 14 and a control switch 15 at a periphery thereof The interior of the base 11 is provided with a control circuit board, the front side of which is provided with a light module 16 containing at least one LED while the rear side of which is provided with a negative-ion generator 17, wherein the control circuit board is electrically connected with the electrical plug 14 and the control switch 15 provided at the periphery of the base 11. The light-passing body 21 is fitted into the opening 12 defined at the top of the base 11, corresponding to the light module 16, so that the light emitting from the light module 16 can pass through the light-passing body. The shade 31 is mounted on top of the base 11, wherein the shade 31 is configured to be a hollow cylinder defining a plurality of light-through holes on a periphery thereof, whereby the light emitting from the light-passing body 21 can go through the light-through holes of the shade 31.

The control switch 15 provided at the base 11 can be a 1-position switch, which can simultaneously control the light module 16 and the negative-ion generator 17. Alternatively, the control switch 15 can be a 3-position switch, which includes a first position, a second position, and a third position, whereby the first position can control the light module 16, the second position can control the negative-ion generator 17, and the third position can control both of the light module 16 and the negative-ion generator 17.

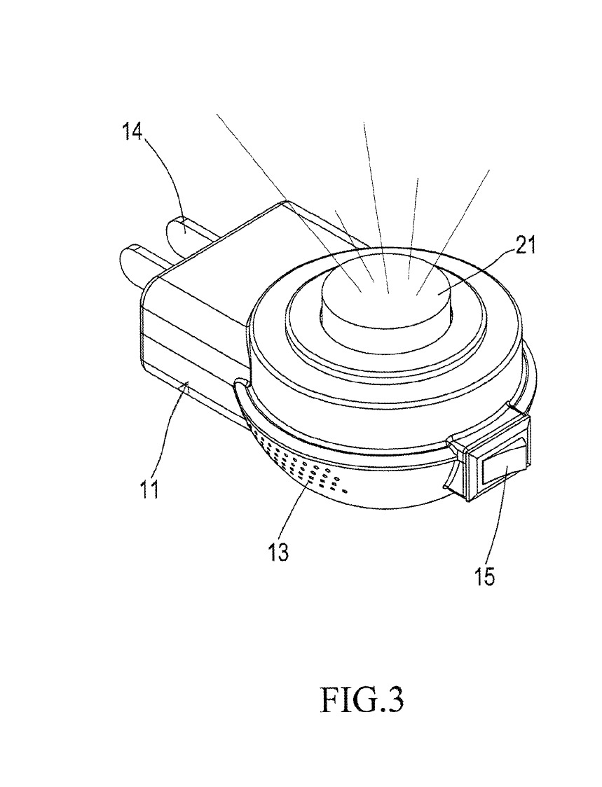

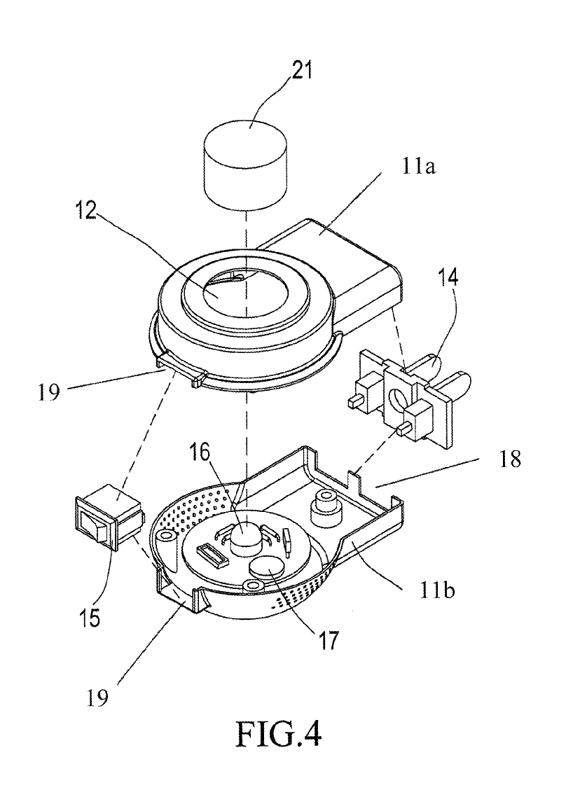

Referring to FIG. 3, when the plug 14 provided at the base 11 is inserted into an electrical socket, the control switch 15 can be triggered to allow the light module 16 on the control circuit board to emit light, which in turn can pass through the light-passing body 21 fitted into the opening 12 of the base 11. The light module 16 can be provided with one LED of high brightness, as shown in FIG. 4, or a plurality of LEDs, as shown in FIG. 2. The negative-ion generator 17 can be provided at the rear side of the control circuit board (see FIG. 2) or at the front side of the control circuit board (see FIG. 4). The negative-ion generator 17 can be activated by the control switch 15 to generate negative ions, which are capable of cleaning the ambient air.

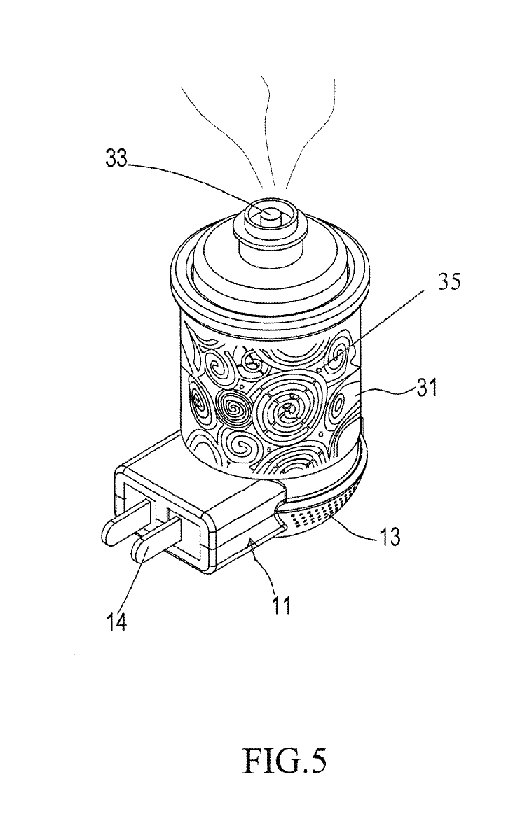

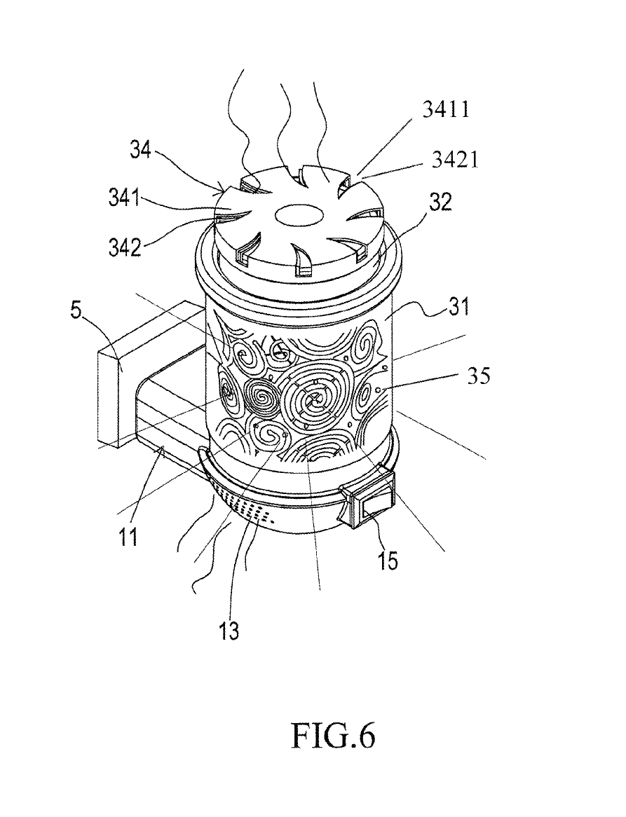

After the shade 31 is mounted on top of the base 11, the interior of the shade 31 can be furnished with a perfume bottle 33, which can be supplied with alcohol, aromatic compounds, water, essential oils, perfumes or balsams of natural plants, or any combinations of the foregoing. The light-passing body 21 can guide the light to go through the light-through holes of the shade 31, so that the lamp of the present invention can create a more distinctive atmosphere, as shown in FIG. 5. Furthermore, as shown in FIG. 6, a container 32 can be furnished in the interior of the shade 31 for holding fragrant wax. Also, the container 32 can be mounted with a cover assembly 34 including an outer slotted cover 341 and an inner slotted cover 342, wherein the outer slotted cover 341 is coaxially aligned with the inner slotted cover 342 and can be rotated relative to the inner slotted cover 342. By rotating the outer slotted cover 341, the slots of the covers 341, 342 can be closed or opened. In use, the plug 14 of the lamp structure can be inserted into an electrical socket 5. Then, the fragrant wax can be put in the container 32. Thereafter, the control switch 15 can be triggered to activate the light module 16 and the negative-ion generator 17, whereby the light emitting from the light module 16 can pass through the light-passing body and go out of the shade 31 via the light-through holes thereof. At the same time, the fragrant wax put in the container 32 can be evaporated naturally at room temperature. With this structure, the lamp of the present invention can be operated more safely. Furthermore, the negative-ion generator 17 can be activated by the control switch 15 to generate negative ions to purify the ambient air. Thus, the present invention can create a fragrant environment more safely to achieve the effect of relaxation, thereby removing the stress of a day.

Although the present invention has been described with a certain degree of particularity, it is understood that the present disclosure is made by way of example only and the combination and arrangement of parts may be resorted to without departing from the spirit and scope of the invention hereinafter claimed.

1. A lamp structure, which comprises:
a base including an upper case and a lower case and defining an interior space therebetween, said upper case defining an opening at a top thereof which communicates with the interior space and said lower case defining a plurality of air holes at a periphery thereof which communicates with the interior space, said upper case and said lower case defining two cutout pairs respectively for receiving therein an electrical plug and a control switch, the interior space of said base provided with a control circuit board including a light module and a negative-ion generator, wherein said control circuit board is electrically connected with said electrical plug and said control switch;
a light-guiding body fitted into the interior space of said base, by way of said opening defined at the top of said upper case of said base, above said light module, so that the light emitting from said light module can be directed by said light-guiding body to go out of said base; and
a shade mounted on top of said base and covering said opening defined at the top of said upper case of said base, wherein said shade is configured to be a hollow cylinder defining a plurality of light-through holes on a periphery thereof, whereby said shade contains an isolated space that can accommodate containers of various styles without interfering with electrical components within said base, the light going out of said base via said light-guiding body can go through said light-through holes of said shade, and the negative ions generated from said negative-ion generator can spread to ambient environment through said air holes defined at the periphery of said lower case of said base.

2. The lamp structure of claim 1, wherein said control switch is a 1-position switch or a 3-position switch.

3. The lamp structure of claim 2, wherein said control switch is a 3-position switch, which includes a first position, a second position, and a third position, whereby said first position can control said light module, said second position can control said negative-ion generator, and said third position can control both of said light module and said negative-ion generator.

4. The lamp structure of claim 1, wherein the interior of said shade is furnished with a perfume bottle.

5. The lamp structure of claim 4, wherein said perfume bottle is supplied with alcohol, aromatic compounds, water, essential oils, perfumes or balsams of natural plants, or any combinations of the foregoing.

6. The lamp structure of claim 1, wherein the interior of said shade is furnished with a container.

7. The lamp structure of claim 6, wherein said container is provided with a cover assembly, at a top end thereof, including an upper slotted cover and a lower slotted cover, each slotted cover defining a plurality of slots, wherein said upper slotted cover is coaxially aligned with said lower slotted cover and can be rotated relative to said lower slotted cover, so that the amount of fragrance scent spreading to ambient environment can be adjusted by rotating said upper slotted cover about said lower slotted cover to change the area of slots communicating with ambient environment.

8. The lamp structure of claim 1, wherein said light module is constructed of LED.

9. A lamp structure, which comprises:
a base defining an interior space therein, a first opening at a top thereof which communicates with the interior space, and a plurality of air holes at a periphery thereof which communicates with the interior space, said base further defining a second opening for receiving therein an electrical plug and a third opening for receiving therein a control switch, the interior space of said base provided with a control circuit board including a light module and a negative-ion generator, wherein said control circuit board is electrically connected with said electrical plug and said control switch;
a light-guiding body fitted into the interior space of said base, by way of the first opening defined at the top of said base, above said light module, so that the light emitting from said light module can be directed by said light-guiding body to go out of said base; and
a shade mounted on top of said base and covering the first opening defined at the top of said base, wherein said shade is configured to be a hollow cylinder defining a plurality of light-through holes on a periphery thereof, whereby said shade contains an isolated space that can accommodate containers of various styles without interfering with electrical components within said base, the light going out of said base via said light-guiding body can go through said light-through holes of said shade, and the negative ions generated from said negative-ion generator can spread to ambient environment through said air holes defined at the periphery of said base.
